(19) United States
(12) Patent Application Publication
(10) Pub. No.: US 2004/0122740 A1
(43) Pub. Date: Jun. 24, 2004

(54) Web site map with author awareness

(76) Inventors: Richard L. McCarrick, Athens, VT (US); Wendi L. Pohs, Westford, MA (US)

Correspondence Address: SCULLY SCOTT MURPHY & PRESSER, PC, 400 GARDEN CITY PLAZA, GARDEN CITY, NY, 11530

(21) Appl. No.: 10/329,311

(22) Filed: Dec. 20, 2002

(51) Int. Cl. G06F 17/60

(52) U.S. Cl. 705/26

(57) ABSTRACT

A method and system for providing customer information. The method comprises the steps of providing content items classified into a categorization taxonomy, each of said items having an author; and editing that taxonomy and adding said items to a web site map, according to the edited taxonomy. The method comprises the further steps of determining person awareness in real time for each said author, and providing a visual indication of that person awareness for each said item on said web site map. Preferably, items are classified with others of related content, each listing of an item in the taxonomy includes the author's name, and the name includes an indication of whether the author is currently available for a real-time chat with the reader. If so, the reader can send a message to the author and conduct an online conversation, obtaining further information personally from the author.

### BACKGROUND OF THE INVENTION

1. Field of the Invention

This invention generally relate to managing Web site information. More specifically, the invention relates to methods and systems for providing customers of Web sites with information about the availability of further communications with authors of items listed on the Web site.

2. Background Art

A good Web site offers readers technical content they can use to help solve issues they are researching. While reading this content, users often may have questions they would like answered by a “real live person” subject matter expert.

Currently, the typical path to contacting such an expert is, first, to find out who wrote the content, second, determine that person's email address (if available), third, email a question to the author, and fourth, wait for an answer. With the current procedure, it is usually very difficult to contact the author or expert in “real time” and to get an immediate answer.

### SUMMARY OF THE INVENTION

An object of this invention is to improve methods and systems for providing customer information on a Web site.

Another object of the invention is to provide an improved procedure that enables Web site users to have communications with experts and authors.

A further object of the invention is to provide a Web site map that enables real time communications between users of a Web site and authors of items listed on the Web site.

These and other objectives are attained with a method and system for providing customer information. The method comprises the step of providing content items classified into a categorization taxonomy, with each of these items having an author. The method comprises the further steps of editing that taxonomy and adding said items to a web site map, according to the edited taxonomy, and determining person awareness in real time for each said author. A visual indication is provided of that person awareness for each said item on the web site map.

Preferably, the present invention uses a Web site map that organizes Web content into a categorized taxonomy. This taxonomy includes (but is not limited to) technical articles, white papers, and discussion forum postings. Items are classified with others of related content; and each listing of an item in the taxonomy includes a subject/title, a short description, and the author's name. The name preferably includes a visual indication of whether the author is currently available for a real-time chat with the reader. If so, the reader can send an instant message to the author and conduct an online conversation, thus obtaining further information directly and personally from the author.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a preferred procedure for implementing the present invention.

FIG. 2 depicts a system for carrying out the invention.

### DETAILED DESCRIPTION OF THE PREFERRED EMBODIMENTS

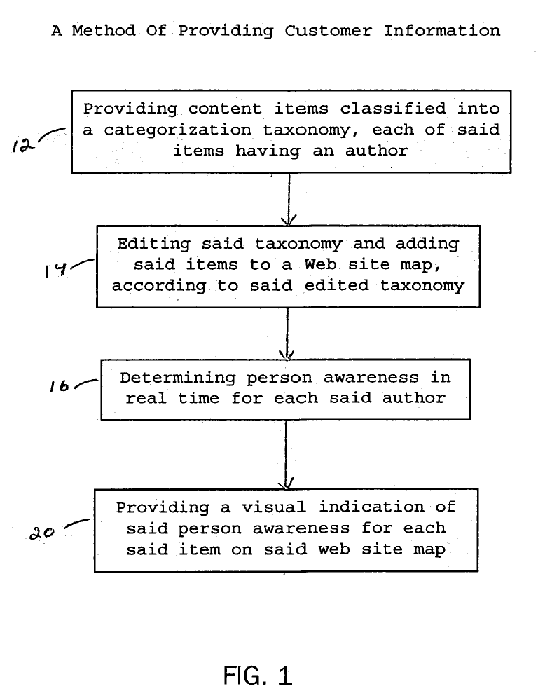

The present invention provides a method and system for providing customer information. With reference to FIG. 1, the method comprises the step 12 of providing content items classified into a categorization taxonomy, with each of these items having an author. The method comprises the further steps 14 and 16 of editing that taxonomy and adding said items to a web site map, according to the edited taxonomy; and determining person awareness in real time for each said author. At step 20, a visual indication is provided of that person awareness for each said item on the web site map.

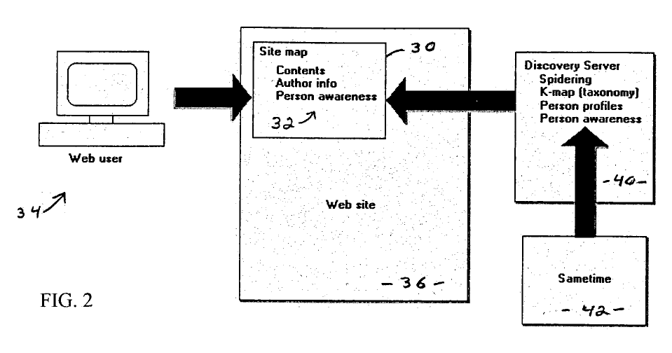

With reference to FIG. 2, the present invention uses a Web site map 30 that organizes Web content into a categorized taxonomy 32. This taxonomy includes (but is not limited to) technical articles, white papers, and discussion forum postings. Items are classified with others of related content, each listing of an item in the taxonomy includes a subject/title, a short description, and the author's name. The name preferably includes a visual indication of whether the author is currently available for a real-time chat with the Web user 34. If so, the Web user can send an instant message to the author and conduct an online conversation, thus obtaining further information directly and personally from the author.

More specifically, the Web user 34 (generally using Internet Explorer or Netscape web browser) accesses a Web site 36. As an aid to navigation, the Web site offers a map of its content. In the preferred configuration of this invention, this site map 30 includes the content of the site, and information about this content including the names of authors of individual documents. This site map is provided by Discovery Server, a Lotus/IBM knowledge management product, represented at 40. Discovery Server software builds the site map, using (1) programs called spiders to read the Web site's content, and (2) a program called a Kmap builder, which creates a taxonomy of the content. This taxonomy is used as the content map for the sites.

An important feature of the preferred embodiment of the invention is person awareness. Through Discovery Server software 40, an awareness and chat software application 42 is accessed. This software application may be Sametime, a Lotus/IBM awareness and chat software application. Discovery Server software 40 checks the name of the author of each document and determines whether they are currently logged onto an accessible Sametime server. If so, a visual indication of this is shown next to the author's name in the site map.

The end result of this would be the following:

User opens the Web page and checks the site map 30,

User finds some interesting content and reads it,

User want to learn more about the content by contacting the author, and

User sees the author is currently online, clicks her name, and starts an instant messaging chat with her.

In addition, it may be noted that the Discovery Server product 40 may perform a Web data search on the site 36, and include person-awareness in the results. This way, awareness can be extended to users who do not use the site map, but instead prefer to simply perform a search.

Readers navigating the site map 30 can thus see whether the author of an item of interest is currently available for an online chat. If so, the reader can log onto the messaging/online meeting software 42 and initiate an online discussion session with the author. Preferably, this discussion can be saved to file, printed or otherwise stored or saved, using the functionality of the messaging/online meeting software.

Any suitable hardware may be used to practice the present invention. For example, the Web user may use any suitable computer or computer network to access Web site 36, and that Web site may be hosted by any suitable server.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method of providing customer information, comprising the steps of:
providing content items classified into a categorization taxonomy, each of said items having an author;
editing said taxonomy and adding said items to a Web site map, according to said edited taxonomy;
determining person awareness in real time for each said author; and
providing a visual indication of said person awareness for each said item on said web site map.

2. A method according to claim 1, wherein the step of providing content items classified into a categorization taxonomy includes the steps of:
providing a Web server with knowledge management software;
using the knowledge management software to organize the content items into a preliminary taxonomy; and
editing the preliminary taxonomy to obtain an edited taxonomy.

3. A method according to claim 2, wherein the step of providing content items classified into a categorization taxonomy includes the further step of using the knowledge management software to check the Web site at defined times for items added to the Web site during a given time period.

4. A method according to claim 1, wherein the step of providing content items includes the step of listing each item on the Web site, each listing of an item also including a subject or title for the item, a description of the item, and the name of the author of the item.

5. A method according to claim 1, wherein the determining step includes the steps of:
providing a Web serer with a messaging/meeting software program; and
said authors, using the software program to identify the authors current availability.

6. A method according to claim 5, further comprising the step of, if the author of the item is identified as currently available, a user of the Web site initiating further communications with said author through the messaging/meeting software program.

7. A system for providing customer information, comprising:
means for providing content items classified into a categorization taxonomy, each of said items having an associated expert;
means for editing said taxonomy and adding said items to a Web site map, according to said edited taxonomy;
means for determining person awareness in real time for each said expert; and
means for providing a visual indication of said person awareness for each said item on said web site map.

8. A system according to claim 7, wherein the means for providing content items classified into a categorization taxonomy includes a Web server with knowledge management software, for using the knowledge management software to organize the content items into a preliminary taxonomy, and for editing the preliminary taxonomy to obtain an edited taxonomy.

9. A system according to claim 8, wherein the Web server further uses the knowledge management software to check the Web site at defined times for items added to the Web site during a given time period.

10. A system according to claim 7, wherein the means for providing content items includes means for listing each item on the Web site, each listing of an item also including a subject or title for the item, a description of the item, and the name of the expert associated with the item.

11. A system according to claim 7, wherein:
the means for determining includes a Web server with a messaging/meeting software program; and
said experts use the software program to identify the experts current availability.

12. A system according to claim 11, wherein the Web server enables a user of the Web site to initiate further communications with one of the experts through the messaging/meeting software program if said one expert is identified as currently available

13. A program storage device readable by machine, tangibly embodying a program of instructions executable by the machine to perform method steps for providing customer information, said method steps comprising:
providing content items classified into a categorization taxonomy, each of said items having an author;
editing said taxonomy and adding said items to a Web site map, according to said edited taxonomy;
determining person awareness in real time for each said author; and
providing a visual indication of said person awareness for each said item on said web site map.

14. A program storage device according to claim 13, wherein the step of providing content items classified into a categorization taxonomy includes the steps of:
using knowledge management software provided on a Web server to organize the content items into a preliminary taxonomy; and
editing the preliminary taxonomy to obtain an edited taxonomy.

15. A program storage device according to claim 14, wherein the step of providing content items classified into a categorization taxonomy includes the further step of using the knowledge management software to check the Web site at defined times for items added to the Web site during a given time period.

16. A program storage device according to claim 13, wherein the step of providing content items includes the step of listing each item on the Web site, each listing of an item also including a subject or title for the item, a description of the item, and the name of the author of the item.

17. A program storage device according to claim 13, wherein the determining step includes the steps of enabling authors, using a messaging/meeting software program on a Web server to identify the authors current availability.

18. A program storage device according to claim 17, wherein said method further comprises the step of a user of the Web site initiating further communications with one of the authors through the messaging/meeting software program if said one of the authors is identified as currently available.
